(19) United States
(12) Patent Application Publication
(10) Pub. No.: US 2015/0116070 A1
(43) Pub. Date: Apr. 30, 2015

(54) COIL COMPONENT

(71) Applicant: TOKO, INC., Tsurugashima-shi (JP)

(72) Inventors: Takumi ARAI, Tsurugashima-shi (JP); Yasutaka MIZUKOSHI, Tsurugashima-shi (JP); Takeo OHAGA, Tsurugashima-shi (JP); Ryota WATANABE, Tsurugashima-shi (JP)

(21) Appl. No.: 14/529,197

(22) Filed: Oct. 31, 2014

(30) Foreign Application Priority Data
Oct. 31, 2013 (JP) 2013-226359

(51) Int. Cl. H01F 27/24; H01F 27/28; H01F 27/29

(52) U.S. Cl. CPC H01F 27/24; H01F 27/29; H01F 27/2823
USPC 336/192

(57) ABSTRACT

A coil component containing a drum core having a winding column, and an upper flange and a lower flange at both ends of the winding column, and a conductive wire wound around the winding column, a ring-type core having a through-hole accommodate the drum core in the through-hole, a pair of metal terminals arranged at outer side surfaces of the ring-type core; wherein each of the metal terminals includes: a side surface portion arranged to face the side surfaces of the ring-type core; a top surface portion bent away from the side surface to the top surface of the core; and a bottom surface portion bent away from the side surface portion to bottom surface of the core; the top surface portion has a pair of claws extending toward the center of the through-hole, the claws being bent toward the inside surface of the through-hole.

### CROSS REFERENCE TO RELATED APPLICATIONS

This application is based upon and claims the benefit of priority from the prior Japanese Patent Application No. 2013-226359, filed on Oct. 31, 2013, the entire contents of which are incorporated herein by reference.

### BACKGROUND OF THE INVENTION

1. Field of the Invention

The present invention relates to a coil component, more specifically a coil component of a closed magnetic circuit, which has a drum core and a ring-type core having a through-hole for inserting the drum core therein.

2. Description of the Related Art

Conventionally, a coil component having a closed magnetic circuit consisting of a combination of a drum core, wound around with insulation-coated conductive wire, and a ring-type core has been used.

Such a coil component is required to ensure that the gap distance between the drum core and the ring-type core is constant in order to limit variability of the characteristics of such coil components. For such a purpose, various proposals have been made so far. In the Japanese patent application laid-open 2003-224026 and the Japanese patent application laid-open 2007-234885, for example, coil components which have a drum core arranged at the center of the through-hole provided at the ring-type core are described, where the drum core is kept apart from the ring-type core by means of the tips of four to six metal terminals inserted into the gap between the drum core and the ring-type core.

### SUMMARY OF THE INVENTION

### Problem to be Solved by the Invention

The coil component abovementioned is capable of positioning the drum core at the center of the through-hole since it can fasten the drum core in more than four directions by means of more than four terminals.

However, a coil component having only two metal terminals is not capable of positioning the drum core at the center of the through-hole since the drum core is fastened in one direction only (See Japanese patent application laid-open 2009-266954). Employing additional components for fastening the drum core raises the total cost of the coil component will increase. In addition, as such added component being made of metal, it could cause eddy currents which affect the electric characteristic of coils.

### Means for Solving the Problem

The coil component according to the present invention is characterized by the provision of a drum core having a winding column, and an upper flange and a lower flange at both ends of the winding column, and a conductive wire wound around the winding column, a ring-type core having a through-hole at the center to accommodate the drum core in the through-hole, a pair of metal terminals arranged at outer side surfaces of the ring-type core; wherein each of the metal terminals includes:

a side surface portion arranged to face the side surfaces of the ring-type core;

a top surface portion bent away from the side surface to the top surface of the ring-type core; and

a bottom surface portion bent away from the side surface portion to bottom surface of the ring-type core;

the top surface portion has a pair of claws extending toward the center of the through-hole, the claws being bent toward the inside surface of the through-hole to regulate the position of the upper flange.

### Effect of the Invention

The coil component of the present invention is advantageous for providing coil components which are inexpensive and have regulated characteristics, since no additional components are required to position the drum core at the center of the through-hole of the ring-type core, even if a coil component has only two terminals.

### BRIEF DESCRIPTION OF THE DRAWINGS

FIG. 1A is a perspective view from above of a coil component according to the present invention;

FIG. 1B is a perspective view from below of a coil component according to the present invention;

FIG. 2 is an exploded perspective view of a coil according to the present invention;

FIG. 3 is a developed view of a metal terminal of the coil component according to the present invention; and

FIG. 4 is a perspective view from below of the positioning of the metal terminal 50 of the coil component according to the present invention.

### DETAILED DESCRIPTION OF THE PREFERRED EMBODIMENT

The coil component according to the present invention will be described below, referring to the drawings.

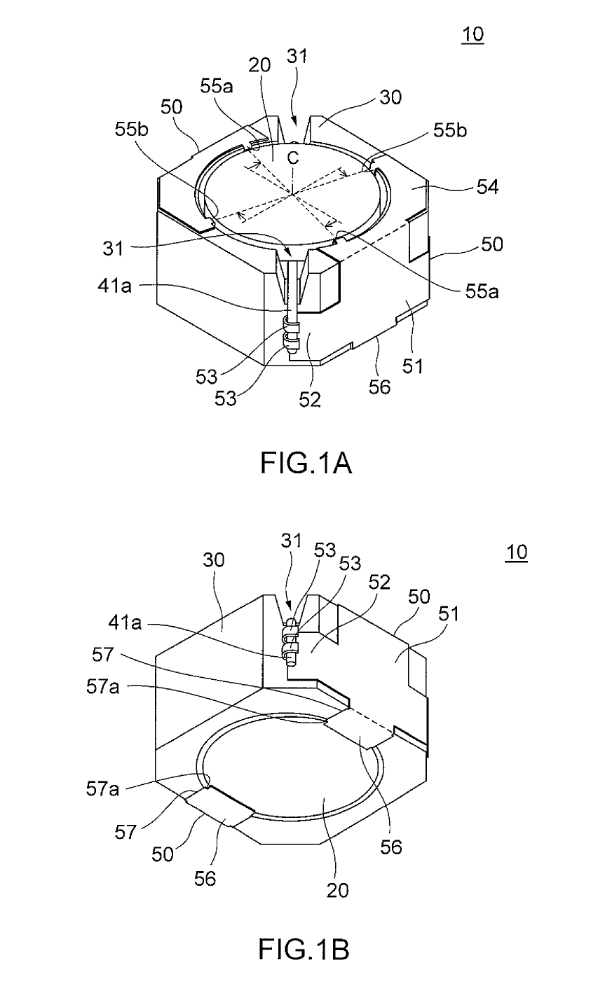

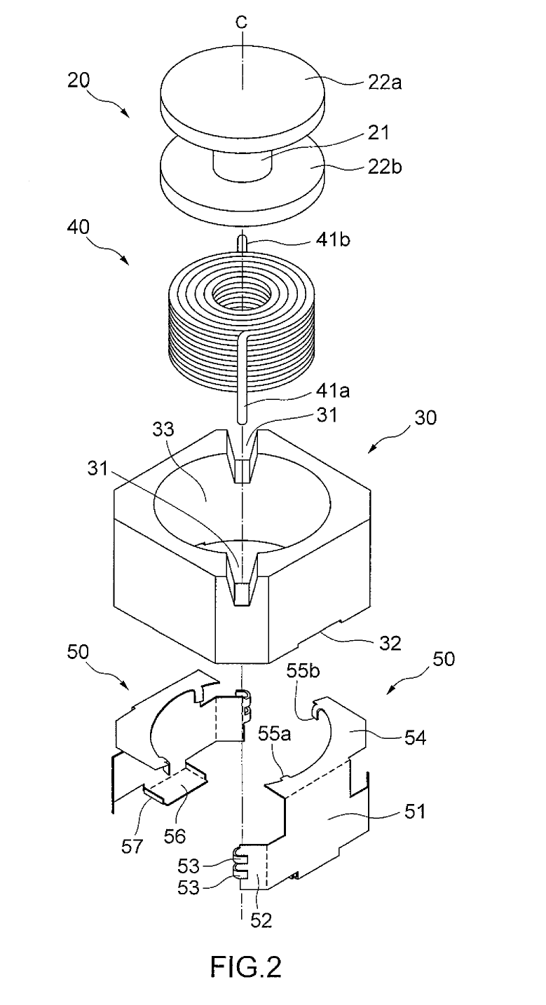

FIG. 1A is a perspective view from above of an embodiment of the present invention, and FIG. 1B is a perspective view from below of the same. FIG. 2 is an exploded perspective view thereof.

As shown in FIGS. 1A, 1B and FIG. 2, a coil component 10 (See FIGS. 1A and 1B) has a drum core 20 (See FIG. 2) having flanges 22a, 22b of circular outlines at both ends of a winding column 21, a winding 40 which consists of a wire or wires coated with insulating material, a ring-type core 30 (see FIGS. 1A and 1B, FIG. 2) having a through-hole 33 of diameter slightly larger than the diameter of the flanges 22a, 22b, and a pair of metal terminals 50, 50 (See FIGS. 1A and 1B, FIG. 2). In FIGS. 1A and 1B and FIG. 2, the center line of the through-hole is shown as C.

In FIG. 2, a winding 40 is wound around the winding column 21 of the drum core 20, and the terminals 41a, 41b of the winding 40 are passed through a groove 31 provided in the corner of the ring-type core 30 to the periphery of the ring-type core 30, and the drum core 20 is inserted into the through-hole 33. Further, the terminals 41a, 41b of the winding 40 are connected to the pair of metal terminals 50, 50 provided at the periphery of the ring-type core 30.

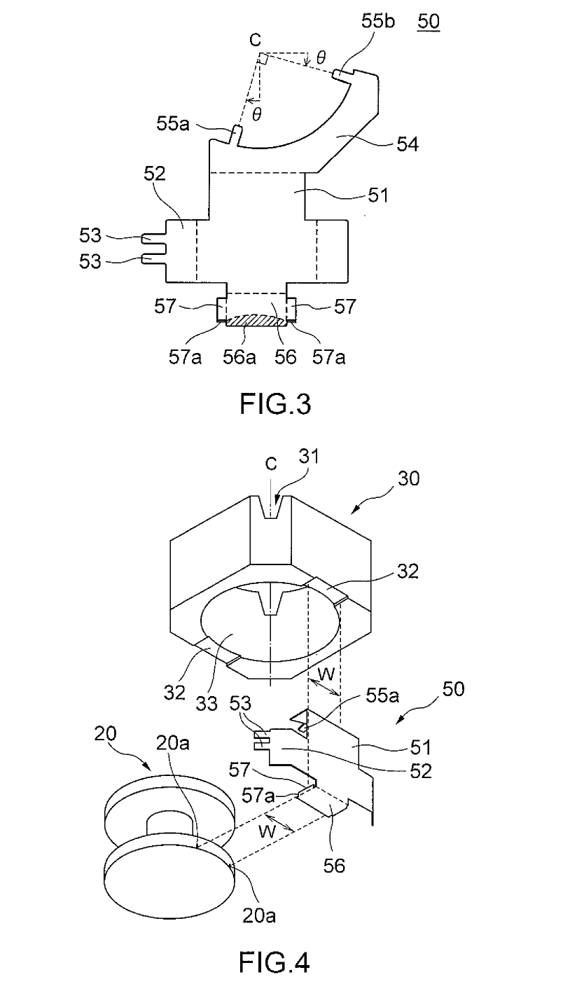

FIG. 3 is a developed view of the metal terminal 50, and FIG. 4 is an exploded perspective view showing the disposition of the drum core 20, the ring-type core 30 and the metal terminal 50. In FIG. 3, one of the metal terminals 50 is shown.

As shown in FIGS. 3 and 4, the metal terminal 50 has a side surface portion 51 which is located on one side at the periphery of the ring-type core 30, a top surface portion 54 bent away from the side surface portion 51 along the top surface of the ring-type core 30, and a fixing portion 52 extending to the chamfered corner of the ring-type core 30, and a bottom surface portion 56 bent away from the side surface portion 51 along the bottom surface of the ring-type core 30. The bottom surface portion 56 is used as a mounting terminal for mounting the coil component on a substrate etc.

In the fixing portion 52, a plurality of J-shaped claws 53 are provided in order to secure the terminals 41a, 41b (FIG. 2) to the metal terminals 50, 50. The metal terminals 50, 50 and the terminals 41a, 41b are electrically connected to each other by soldering, solder dipping, welding, or heat bonding, etc.

At the top surface portion 54, the claws 55a, 55b are provided at a position extending to the center C at an angle of 90 degrees with the plan view. The claws 55a, 55b are bent perpendicularly into the inside walls of the through-hole 33 of the ring-type core 30.

In the embodiment of the present invention, to avoid the groove 31, to minimize the length of the top surface portion 54, the claws 55a, 55b are arranged to rotate only by the angle θ as shown in FIG. 3.

The claws 55a, 55b can be very small in size since they merely serve as spacers in order to prevent that the upper flange 22a of the drum core 20 contacts the ring-type core 30 and so as to keep constant the gap between the upper flange 22a of the drum core 20.

In a case the claws 55a, 55b need not be bent to a 90 degrees angle with the top surface portion 54, and in a case the gap between the drum core 20 and the ring-type core 30 exceeds the thickness of the metal terminals 50, the claws 55a, 55b can serve to hold the drum core 20 by the pressing force of the claws 55a, 55b.

Standing portions 57, 57 are perpendicularly provided at both side ends of the bottom surface portion 56 so as to form a U-shaped section. The furrow 32 is provided at the bottom surface of the ring-type core 30, the inside width of the furrow 32 being almost equal to the outside width (“w” in FIG. 4) of the standing portions 57, 57. The U-shaped portion is arranged to be inserted in the furrow 32 so that the outer surface of the standing portions 57, 57 and the inner surface of the furrow 32 directly contact each other.

Further, a tip portion 56a (hatched portion in FIG. 3) of the bottom surface portion 56 contacts the bottom surface of the lower flange 22b, and an end surface 57a of the standing portion 57 of the metal terminal 50 contacts the outer periphery of the lower flange 22b (“20a” in FIG. 4) to regulate the position of the lower flange 22b of the drum core 20.

In the coil component abovementioned, the position of the upper flange 22a (FIG. 2) is regulated at the four corners by the claws 55a, 55b, provided on the pair of metal terminals 50 respectively, and the lower flange 22b's position is regulated by the tip portions 56a and the end surface 57a. Thus, the center of the drum core 20 is securely positioned at the center C of the through-hole 33 of the ring-type core 30.

The small surface of the claws 55a, 55b which are inserted between the drum core 20 and the ring-type core 30 means that it is improbable that the characteristics of the coil component will be affected by the occurrence of eddy currents in the metal terminal 50.

### Explanation of Codes

10 coil component
20 drum core
30 ring-type core
31 groove
32 furrow
33 through-hole
40 winding
41a, 41b terminal
50 metal terminal
51 side surface portion
52 fixing portion
54 top surface portion
53, 55a, 55b claw
56 bottom surface portion
57 standing portion

What is claimed is:

1. A coil component comprising a drum core having a winding column, and an upper flange and a lower flange at both ends of the winding column, and a conductive wire wound around the winding column, a ring-type core having a through-hole at the center to accommodate the drum core in the through-hole, a pair of metal terminals arranged at outer side surfaces of the ring-type core; wherein each of the metal terminals includes:
a side surface portion arranged to face the side surfaces of the ring-type core;
a top surface portion bent away from the side surface to the top surface of the ring-type core; and
a bottom surface portion bent away from the side surface portion to bottom surface of the ring-type core;
the top surface portion has a pair of claws extending toward the center of the through-hole, the claws being bent toward the inside surface of the through-hole to regulate the position of the upper flange.

2. A coil component claimed in claim 1, wherein
the outlines of the upper flange and the lower flange are circular.

3. A coil component claimed in claim 2, wherein
the pair of claws make angle of 90 degrees with the center line of the through-hole.

4. A coil component claimed in claim 3, wherein
the bottom surface portion is bent at the both side ends toward upside to make U-shape, and is inserted in the furrow.

5. A coil component claimed in claim 4, wherein
the metal terminal includes a fixing portion extending from the side surface portion, the tip of the fixing portion being bent to make J-character shape to lock the terminal.
